(19) United States
(12) Patent Application Publication
(10) Pub. No.: US 2008/0170299 A1
(43) Pub. Date: Jul. 17, 2008

(54) Imaging device and an imaging apparatus including the imaging device

(75) Inventor: Masaru Kawabata, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/008,547

(22) Filed: Jan. 11, 2008

(30) Foreign Application Priority Data
Jan. 15, 2007 (JP) P2007-005722

(51) Int. Cl. G02B 3/12

(52) U.S. Cl. 359/665

(57) ABSTRACT

An imaging device includes: a plurality of photoelectric conversion devices configured to convert a received light into an electronic signal; a plurality of collector lenses configured to collect a light and to supply the light to the photoelectric conversion devices, the collector lenses being arranged before each of the photoelectric conversion devices; and a fluid lens configured to refract a light and to supply the light to the collector lenses, the fluid lens being arranged before the collector lenses, wherein the fluid lens has a first and second fluids with refractive indices different from each other and an electrode that applies a voltage to the first and second fluids, and the fluid lens changes an interface topology between the fluids in accordance with a voltage to be applied to the electrode and varies a refractive index of a light supplied to each of the plurality of the collector lenses.

### CROSS REFERENCES TO RELATED APPLICATIONS

The present invention contains subject matter related to Japanese Patent Application JP 2007-005722 filed in the Japanese Patent Office on Jan. 15, 2007, the entire contents of which being incorporated herein by reference.

### BACKGROUND OF THE INVENTION

1. Field of the Invention

The present invention relates to an imaging device, particularly to an imaging device which receives lights and converts the lights into electronic signals, and an imaging apparatus including the imaging device.

2. Description of the Related Art

An imaging device for use in an imaging apparatus receives lights from a subject and converts the lights into electronic signals. For example, an imaging device like this, a CCD (Charge Coupled Device) sensor and a CMOS (Complementary Metal Oxide Semiconductor) sensor are used.

In recent years, the imaging apparatus is increasingly scaled down, and also in the imaging device, the pitches and openings of arranging sensors become narrower and narrower for higher density. In order to cope with a higher density of devices, an imaging device is proposed that the internal structure of the imaging device is improved. For example, an imaging device is proposed that a transfer electrode is buried in a substrate so as not to block the light that obliquely enters (for example, see Patent Reference 1 (JP-A-2002-246583 (FIG. 1))).

On the other hand, an optical lens group for use in an imaging apparatus is known that the characteristics of the overall optical lens group are changed depending on the positions of the lenses configuring the group (for example, see Patent Reference 2 (JP-A-2004-004566 (FIGS. 6 to 15))). These characteristics of the lenses are categorized into the spherical aberration showing a phenomenon that a light beam is not fixed at one point on the optical axis, the astigmatism showing a phenomenon that the image formation point of a concentric image is not matched with the image formation point of a radiant image, and the distortion showing a phenomenon that an object and an image are not analog.

Therefore, in the imaging device, desirably, the influence caused by the characteristics of the optical lens group is avoided as much as possible.

### SUMMARY OF THE INVENTION

However, the imaging device is formed in much higher density, and then a light quantity reaching a photoelectric conversion device itself is reduced, which causes the difficulty of avoiding the influence caused by the characteristics of the optical lens group. For example, as shown in FIG. 9A, in the case in which lights enter from the front side, the lights incident through an on-chip lens 211 are uniformly supplied to a photoelectric conversion device 231. However, as shown in FIG. 9B, in the case in which the incident angle of lights becomes tilted, so-called “light beam shading” occurs in the lights incident through the on-chip lens 212 (402), and then the lights do not reach the photoelectric conversion device 232. Then, as shown in FIG. 9C, in the case in which the incident angle of lights becomes more tilted, the lights are all reflected in the surface of the on-chip lens 213 (403), the lights do not enter inside the imaging device, and the light quantity received in the photoelectric conversion device 233 becomes smaller. As described above, the light quantity received in the photoelectric conversion device is reduced to decrease the illuminance, which might cause a degraded image quality of a taken image. In addition, it might affect the performance such as an auto exposure function.

It is desirable that lights are allowed to vertically enter each of photoelectric conversion devices to maintain light quantities in an imaging device.

An imaging device according to an embodiment of the invention is an imaging device including: a plurality of photoelectric conversion devices configured to convert a received light into an electronic signal; a plurality of collector lenses configured to collect a light and to supply the light to the plurality of the photoelectric conversion devices, the collector lenses being arranged before each of the plurality of the photoelectric conversion devices; and a fluid lens configured to refract a light and to supply the light to the plurality of the collector lenses, the fluid lens being arranged before the plurality of the collector lenses, wherein the fluid lens has a first fluid and a second fluid with refractive indices different from each other and an electrode that applies a voltage to the first fluid and the second fluid, and the fluid lens changes an interface topology between the first fluid and the second fluid in accordance with a voltage to be applied to the electrode and varies a refractive index of a light supplied to each of the plurality of the collector lenses. Accordingly, an advantage is obtained that in accordance with the voltage to be applied to the electrode of the fluid lens, the refractive index of the light supplied to each of the plurality of the collector lenses is changed.

In addition, in the embodiment of the invention, a liquid may be used for the first and the second fluid. In this case, the first fluid may be an insulating oil, and the second fluid may be a conductive aqueous solution.

In addition, an imaging apparatus according to another embodiment of the invention is an imaging apparatus including: a plurality of photoelectric conversion devices configured to convert a received light into an electronic signal; a plurality of collector lenses configured to collect a light and to supply the light to the plurality of the photoelectric conversion devices, the collector lenses being arranged before each of the plurality of the photoelectric conversion devices; a fluid lens configured to refract a light and to supply the light to the plurality of the collector lenses, the fluid lens being arranged before the plurality of the collector lenses; and a solid lens group configured to allow a light from a subject to enter the fluid lens, the solid lens group being arranged before the fluid lens, wherein the fluid lens has a first fluid and a second fluid with refractive indices different from each other and an electrode that applies a voltage to the first fluid and the second fluid, and the fluid lens changes an interface topology between the first fluid and the second fluid in accordance with a voltage to be applied to the electrode and varies a refractive index of a light supplied to each of the plurality of the collector lenses. Accordingly, an advantage is obtained that in supplying the light inputted from the solid lens group to each of the plurality of the collector lenses, the refractive index is changed in accordance with the voltage to be applied to the electrode of the fluid lens.

In addition, in the embodiment of the invention, the imaging apparatus may further include a lens position sensor configured to detect at least one position of a lens in the solid lens group, wherein a voltage to be applied to the electrode is changed in accordance with the position of the lens detected by the lens position sensor. Accordingly, an advantage is obtained that the refractive index is changed in accordance with the position of the lens.

In addition, in the embodiment of the invention, the imaging apparatus may further include an angular velocity sensor configured to detect an angular velocity applied to imaging apparatus, wherein a voltage to be applied to the electrode is changed in accordance with an angular velocity detected by the angular velocity sensor. Accordingly, an advantage is obtained that the refractive index is changed in accordance with the angular velocity.

In addition, in the embodiment of the invention, the imaging apparatus may further include a temperature sensor configured to detect an ambient temperature of imaging apparatus, wherein a voltage to be applied to the electrode is changed in accordance with a temperature detected by the temperature sensor. Accordingly, an advantage is obtained that the refractive index is changed in accordance with the temperature.

In addition, an imaging method according to a further embodiment of the invention is an imaging method of an imaging device having a plurality of photoelectric conversion device, a plurality of collector lenses arranged before each of the plurality of the photoelectric conversion devices, and a fluid lens arranged before the plurality of the collector lenses, the method including the step of: refracting a light and supplying the light to each of the plurality of the collector lenses while an interface topology between a first fluid and a second fluid being changed in accordance with a voltage to be applied to an electrode, wherein the fluid lens having the first fluid and the second fluid with refractive indices different from each other, and having the electrode that applies a voltage to the first fluid and the second fluid; collecting the light supplied from the fluid lens by the plurality of the collector lenses and supplying the light to the plurality of the photoelectric conversion devices; and receiving the light supplied from the plurality of the collector lenses by the plurality of the photoelectric conversion devices and converting the light into an electronic signal. Accordingly, an advantage is obtained that in accordance with the voltage to be applied to the electrode of the fluid lens, the refractive index of the light supplied to each of the plurality of the collector lenses is changed.

In addition, an imaging method according to a still further embodiment of the invention is an imaging method of an imaging apparatus having a plurality of photoelectric conversion device, a plurality of collector lenses arranged before each of the plurality of the photoelectric conversion devices, a fluid lens arranged before the plurality of the collector lenses, and a solid lens group arranged before the fluid lens, the method including the steps of: allowing a light from a subject to enter the fluid lens by the solid lens group; refracting the light inputted by the solid lens group and supplying the light to each of the plurality of the collector lenses while an interface topology between a first fluid and a second fluid being changed in accordance with a voltage to be applied to an electrode, wherein the fluid lens having the first fluid and the second fluid with refractive indices different from each other and having the electrode that applies a voltage to the first fluid and the second fluid; collecting the light supplied from the fluid lens by the plurality of the collector lenses and supplying the light to the plurality of the photoelectric conversion devices; and receiving the light supplied from the plurality of the collector lenses by the plurality of the photoelectric conversion devices and converting the light into an electronic signal. Accordingly, an advantage is obtained that in supplying the light inputted from the solid lens group to each of the plurality of the collector lenses, the refractive index is changed in accordance with the voltage to be applied to the electrode of the fluid lens.

According to the embodiments of the invention, an excellent advantage can be exerted that lights are allowed to vertically enter each of the photoelectric conversion devices to maintain the light quantity in an imaging device.

### BRIEF DESCRIPTION OF THE DRAWINGS

FIG. 1 shows a diagram depicting an exemplary cross sectional structure partially showing an imaging device according to an embodiment of the invention;

FIGS. 2a to 2C show a diagram depicting an exemplary relation between a voltage to be applied to a fluid lens and media according to an embodiment of the invention;

FIG. 3 shows a perspective view depicting an exemplary structure of a part of a solid state imaging device shown in FIG. 1;

FIG. 4 shows a top view depicting an exemplary structure of a part of the solid state imaging device shown in FIG. 1;

FIGS. 5A to 5C show a diagram depicting an exemplary incident angle of lights received in the imaging device according to an embodiment of the invention;

FIG. 6 shows a diagram depicting an exemplary configuration of an imaging apparatus according to an embodiment of the invention;

FIGS. 7A to 7C show a diagram depicting an exemplary arrangement of a solid lens group 310;

FIGS. 8A and 8B show a diagram depicting a modification of the imaging device according to an embodiment of the invention; and

FIGS. 9A to 9C show a diagram depicting an exemplary incident angle of lights received in an imaging device before.

### DETAILED DESCRIPTION OF THE INVENTION

Next, an embodiment of the invention will be described in detail with reference to the drawings.

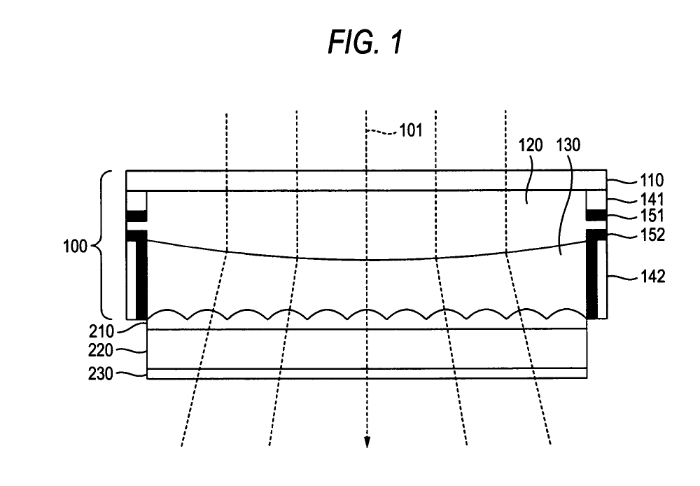

FIG. 1 shows a diagram depicting an exemplary cross sectional structure partially showing an imaging device according to an embodiment of the invention. The imaging device includes an on-chip lens 210, a glass layer 220, and a photoelectric conversion device 230 as a solid state imaging device. The photoelectric conversion device 230 is arranged flat in multiple numbers as corresponding to individual pixels, which receives a light 101 from a subject and converts the received light into electronic signals. The on-chip lens 210 is arranged flat in multiple numbers as corresponding to each of the photoelectric conversion devices 230, which collects the light 101 from the subject and supplies it to the photoelectric conversion device 230. The glass layer 220 intermediates between the on-chip lens 210 and the photoelectric conversion device 230. For the glass layer 220, a color filter may be used that selectively transmits any one of red, blue, and green lights for each of the photoelectric conversion devices 230. Moreover, for the solid state imaging device, a publicly known solid state imaging device can be used (for example, see JP-A-2002-246583).

On the top of the on-chip lens 210, a fluid lens 100 is provided. The fluid lens 100 is formed in which a medium A (120) and a medium B (130) with refractive indices different from each other are sealed with a glass layer 110. The fluid lens 100 is provided with electrodes 141 and 142 through insulating layers 151 and 152. The interface topology between the medium A (120) and the medium B (130) is changed in accordance with a voltage to be applied to the electrodes 141 and 142. Moreover, for the fluid lens 100, a publicly known fluid lens can be used (for example, see JP-A-2000-347005).

For example, for the medium A (120), an insulating oil can be used. In addition, for the medium B (130), for example, a conductive aqueous solution can be used. With this configuration, as described below, the strength of the water repellency of an aqueous solution is varied in accordance with the voltage to change the interface topology.

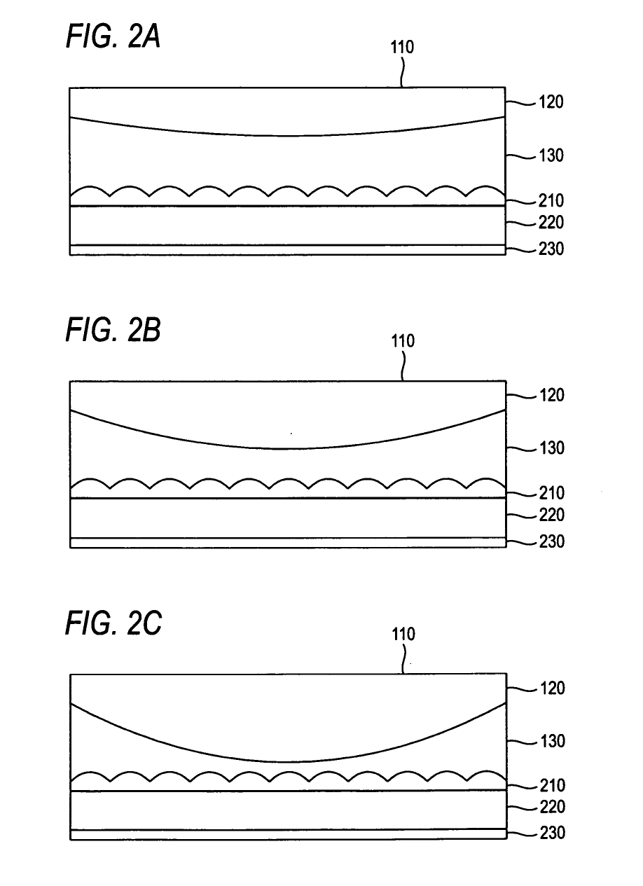

FIGS. 2A to 2C show a diagram depicting an exemplary relation between a voltage to be applied to the fluid lens and the media according to an embodiment of the invention. In the case in which the voltage to be applied to the electrodes 141 and 142 is low, the interface topology between the medium A (120) and the medium B (130) has a gentle curve as shown in FIG. 2A.

In contrast to this, as the voltage to be applied to the electrodes 141 and 142 is increased, due to an Electro-Wetting phenomenon, the curvature of the interface topology is changed as show in FIG. 2B. Then, the voltage is increased to a predetermined voltage, and then the curvature becomes one shown in FIG. 2C. As discussed above, the fluid lens functions as a curvature variable concave lens.

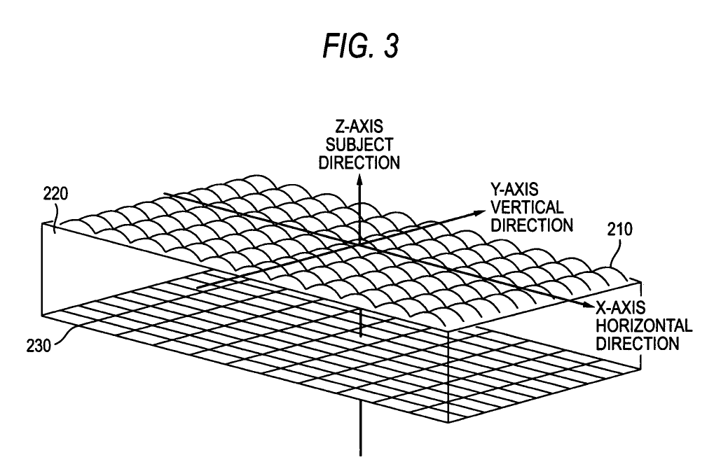

FIG. 3 shows a perspective view depicting an exemplary structure of apart of the solid state imaging device shown in FIG. 1. As described above, the imaging device according to the embodiment of the invention includes a solid state imaging device, and the solid state imaging device has the on-chip lens 210, the glass layer 220, and the photoelectric conversion device 230.

The photoelectric conversion device 230 and the on-chip lens 210 are arranged in multiple numbers so as to make a pair on a plane (a plane horizontal to a plane including the X-axis and the Y-axis) vertical to the subject direction (the Z-axis direction). Each of the photoelectric conversion devices 230 is screened by a light shielding film. The glass layer 220 is provided as an intermedium between the photoelectric conversion device 230 and the on-chip lens 210.

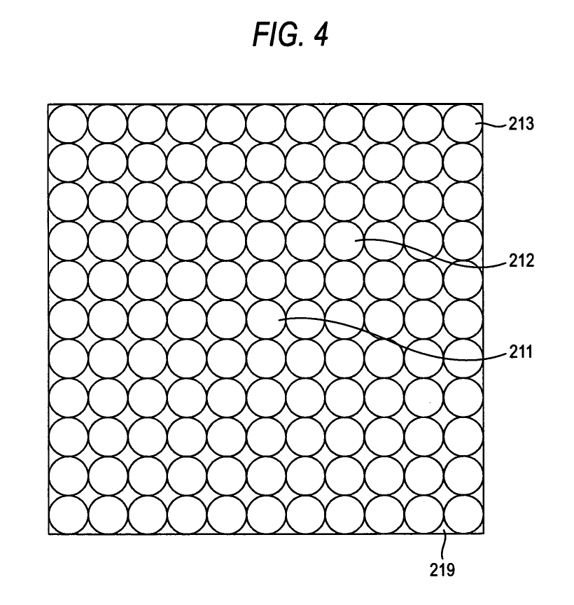

FIG. 4 shows a top view depicting an exemplary structure of a part of the solid state imaging device shown in FIG. 1. As described above, a plurality of the on-chip lenses is arranged on the top of the solid state imaging device. Outside the effective diameter of each of the on-chip lenses, an insulating film 219 is formed.

Here, the incident angle of lights will be considered as focusing on three on-chip lenses, an on-chip lens 211 near the center of the solid state imaging device, an on-chip lens 213 near the rim part thereof, and an on-chip lens 212 near the place therebetween.

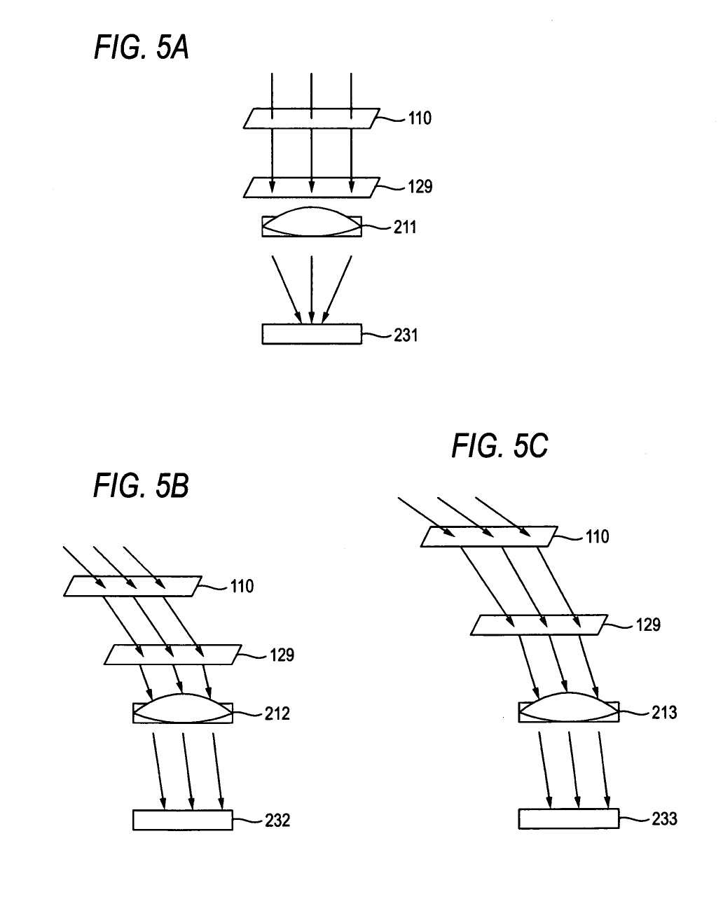

FIGS. 5A to 5C show a diagram depicting an exemplary incident angle of lights received in the imaging device according to the embodiment of the invention. As shown in FIG. 5A, in the case in which lights enter from the front side of the glass layer 110, the lights incident through the on-chip lens 211 from the interface 129 between the medium A (120) and the medium B (130) are uniformly supplied to the photoelectric conversion device 231.

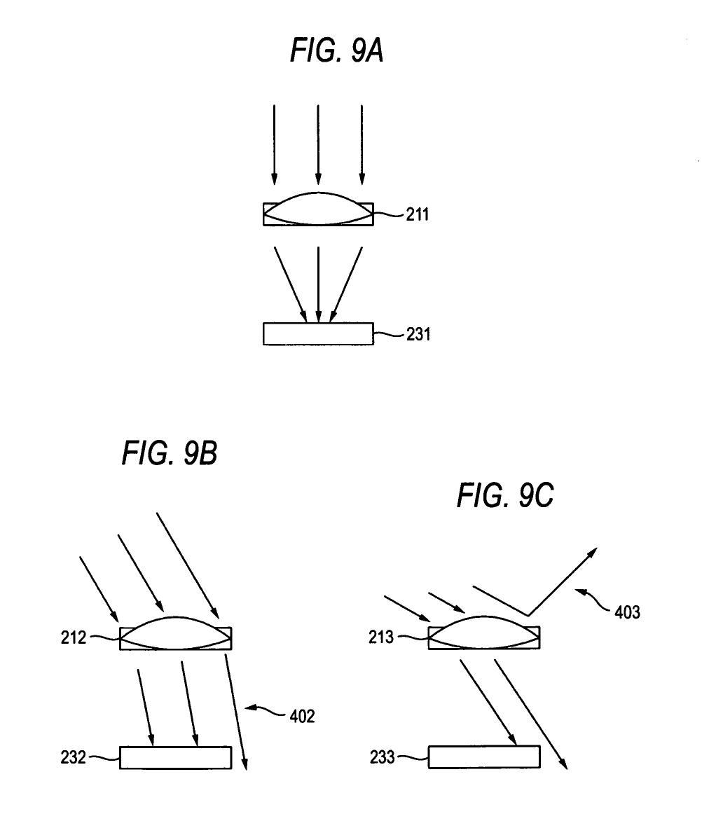

In addition, as shown in FIG. 5B, in the case in which lights obliquely enter the glass layer 110, the incident angle of the lights refracted by the medium A (120) is changed on the border of the interface 129, and the lights pass through the medium B (130) and are supplied to the on-chip lens 212. Therefore, different from the case of FIG. 9B, the photoelectric conversion device 232 receives the lights from the on-chip lens 212 with no occurrence of light beam shading.

Then, as shown in FIG. 5C, in the case in which lights more obliquely enter the glass layer 110, the incident angle of the lights refracted by the medium A (120) is changed on the border of the interface 129, and the lights pass through the medium B (130) and are supplied to the on-chip lens 213. Therefore, different from the case of FIG. 9C, the photoelectric conversion device 232 receives the lights from the on-chip lens 213 with no all reflection.

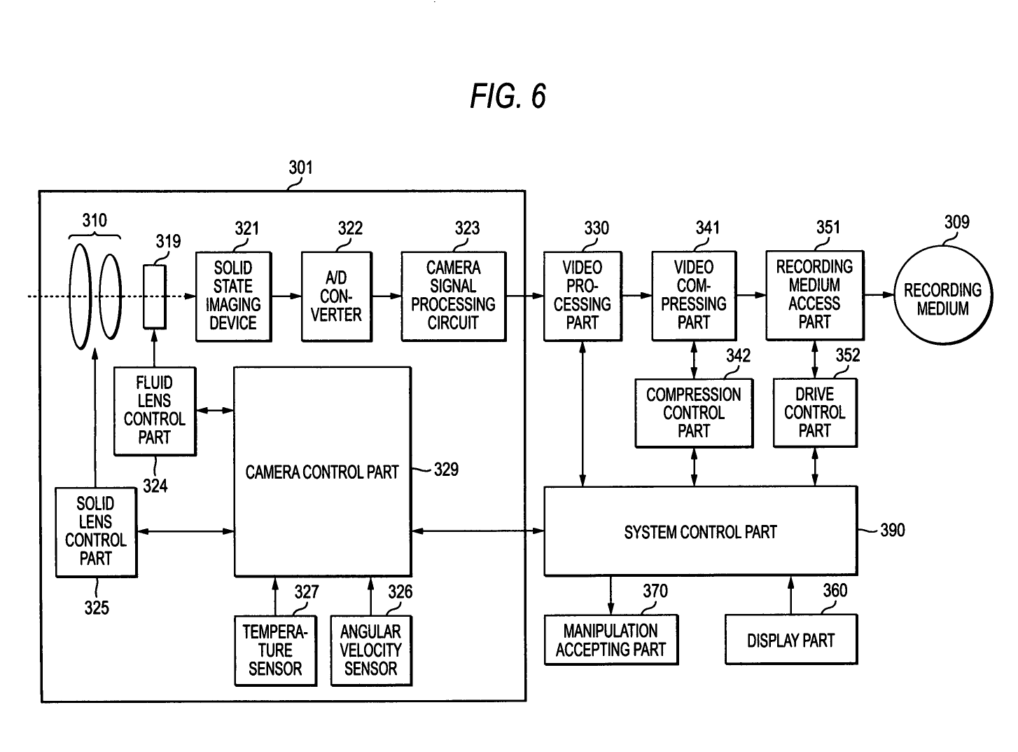

FIG. 6 shows a diagram depicting an exemplary configuration of an imaging apparatus according to an embodiment of the invention. The imaging apparatus has an imaging part 301, a video processing part 330, a video compressing part 341, a compression control part 342, a recording medium access part 351, a drive control part 352, a manipulation accepting part 360, a display part 370, and a system control part 390.

The imaging part 301 shoots a subject and outputs it as video data. The video processing part 330 applies effects to the video data outputted from the imaging part 301. The video compressing part 341 compresses the video data processed in the video processing part 330. The compression control part 342 controls the compression process in the video compressing part 341.

The recording medium access part 351 writers and reads data on the recording medium 309. The drive control part 352 controls data write and read by the recording medium access part 351.

The manipulation accepting part 360 accepts a user manipulation input, for which various buttons and GUIs (Graphical User Interface) are considered. The display part 370 displays video currently being taken, reproduced video, or various messages for a user.

The system control part 390 controls the overall imaging apparatus, which can be implemented by a microprocessor, for example. The system control part 390 controls the start and stop of video recording, and information about the elapsed time of recording by a manipulation input accepted by the manipulation accepting part 360 as well as controls the display in the display part 370 for a user. In addition, the system control part 390 exchanges information with the camera control part 329 and the compression control part 342, and controls data write on the recording medium 309 through the drive control part 352.

In addition, the imaging part 301 has a solid lens group 310, a fluid lens 319, a solid state imaging device 321, an A/D converter 322, a camera signal processing circuit 323, a fluid lens control part 324, a solid lens control part 325, an angular velocity sensor 326, a temperature sensor 327, and a camera control part 329.

The solid lens group 310 collects lights from a subject, which is configured of a so-called front cell, a zoom lens, a focus lens, and an image stabilizer lens. The zoom lens is a lens for zooming (close-up) process. The focus lens is a lens that focuses the subject. The image stabilizer lens is a lens that corrects an unstable taken image caused by handshakes or vibrations. The solid lens group 310 is housed in a lens barrel together with a diaphragm mechanism.

The fluid lens 319 is a lens that refracts the lights supplied from the solid lens group 310 and supplies the lights to the solid state imaging device 321. As described above, the fluid lens 319 is a lens that a medium A and a medium B with refractive indices different from each other are sealed with the glass layer, which changes the interface topology between the medium A and the medium B in accordance with the voltage to be applied.

The solid state imaging device 321 is a photoelectric conversion device that converts the lights supplied from the fluid lens 319 into electric signals. By the solid state imaging device 321, a subject image is taken out as three video signals corresponding to three primary colors of RGB (red, green, blue), for example.

The A/D converter 322 is a device that converts analog electric signals supplied from the solid state imaging device 321 into digital signals. The camera signal processing circuit 323 is a circuit that subjects the digital signals converted in the A/D converter 322 to signal processing such as white balance to define white color.

The solid lens control part 325 is a device that controls the position of the lens in the solid lens group 310 in accordance with a manipulation input from the user and the angular velocity detected in the angular velocity sensor 326. The position of the lens decided in the solid lens control part 325 is sent to the fluid lens control part 324 through the camera control part 329. Moreover, for the lens whose position is decided here, the zoom lens and the focus lens are considered.

The angular velocity sensor 326 is a device that detects the angular velocity applied to the imaging apparatus, which can be implemented by a gyroscope, for example. Since the angular velocity determines the inclination (so-called six positions) of the imaging apparatus, the influence of gravity on the fluid lens 319 can be grasped. The angular velocity detected in the angular velocity sensor 326 is sent to the fluid lens control part 324 through the camera control part 329.

The temperature sensor 327 is a device that detects the ambient temperature of the imaging apparatus, which is implemented by a thermistor, for example. The temperature sensor 327 can grasp the influence of temperature on the viscosities of the media A and B of the fluid lens 319. The temperature detected in the temperature sensor 327 is sent to the fluid lens control part 324 through the camera control part 329.

The camera control part 329 controls the imaging part 301. For example, the camera control part 329 conducts process control in the solid lens control part 325, process control in the fluid lens control part 324, and video input control, the video inputted from the solid state imaging device 321.

The fluid lens control part 324 controls the voltage to be applied to the fluid lens 319 to control the interface topology between the medium A and the medium B. For the factors that affect the voltage in the fluid lens control part 324, the following can be considered: (1) the position of the lens in the solid lens group 310, (2) the angular velocity that is detected in the angular velocity sensor 326 and applied to the imaging apparatus, and (3) the ambient temperature of the imaging apparatus detected in the temperature sensor 327. A table is provided that holds the relation between these values and the voltage value, and the table is referenced, whereby the voltage to be applied to the fluid lens 319 can be decided. Moreover, for a drive method of voltage, the following modes can be used: the voltage variable mode in which the voltage is controlled in accordance with the magnitude of voltage, or the pulse width modulation mode in which the voltage is controlled in accordance with pulse width.

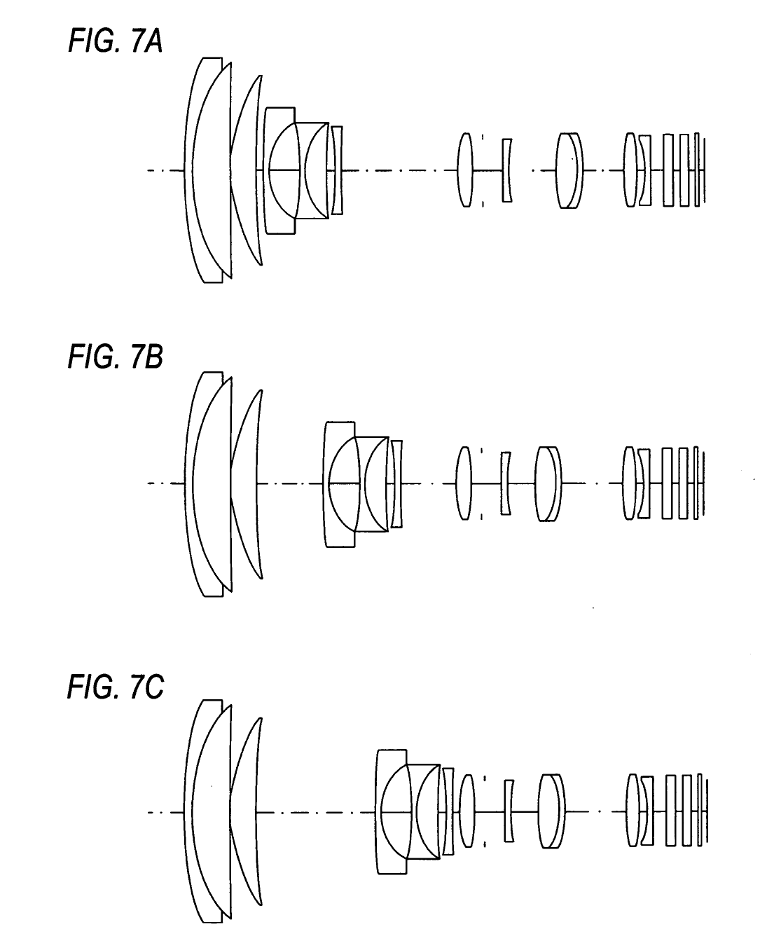

FIGS. 7A to 7C show a diagram depicting an exemplary arrangement of the solid lens group 310. Here, it is supposed that lights enter from left. FIG. 7A shows an example that the lenses are arranged on the wide angle side. In addition, FIG. 7C shows an example that the lenses are arranged on the telephoto side. On the other hand, FIG. 7B shows an intermediate example that the lenses are arranged on the middle position.

As described above, depending on the arrangement of the lenses, the lens characteristics such as astigmatism are varied. In the embodiment of the invention, the positions of the lenses in the solid lens group 310 are sent from the solid lens control part 325 to the fluid lens control part 324 through the camera control part 329, whereby the voltage to be applied to the fluid lens 319 can be changed in accordance with the positions of the lenses in the solid lens group 310.

As described above, according to the embodiment of the invention, the voltage to be applied to the fluid lens 319 is controlled in accordance with the positions of the lenses in the solid lens group 310, the angular velocity of the imaging apparatus, and the ambient temperature of the imaging apparatus, whereby the interface topology between the medium A (120) and the medium B (130) is controlled to allow the lights from the subject to vertically enter each of the photoelectric conversion devices in the imaging device. Thus, the light quantity can be maintained in the imaging device, and the degradation of the image quality of a taken image can be prevented.

Moreover, in the embodiments of the invention, as described in FIG. 1, the example is described in which the voltage is applied in the vertical direction of the optical axis, but an embodiment of the invention is not restricted thereto. For example, such a scheme may be possible in which a transparent electrode is provided on the glass layer 110 side and the voltage from the fluid lens control part 324 is applied to the transparent electrode. In addition, such a scheme may be possible in which a transparent electrode is provided on the surface of the on-chip lens 210 and the voltage controlled from the fluid lens control part 324 is applied to the transparent electrode.

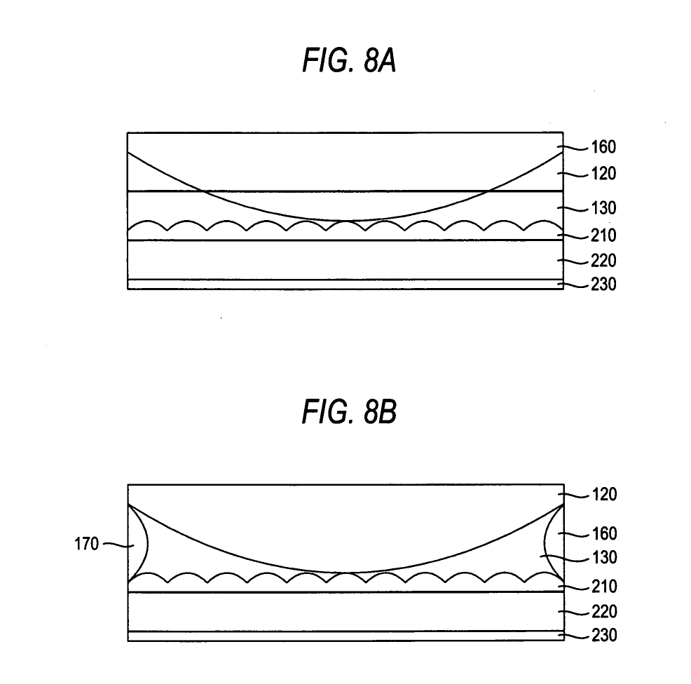

In addition, in the embodiment of the invention, as described in FIG. 1, the example is described in which two media, the media A and B are used, but an embodiment of the invention is not restricted thereto. For example, as shown in FIG. 8A, three media, a medium A (120), a medium B (130) and a medium C (160) may be used. In addition, as shown in FIG. 8B, four media, a medium A (120), a medium B (130), a medium C (160) and a medium D (170) may be used.

Moreover, the embodiment of the invention shows an example of implementing an embodiment of the invention, having correspondences to specific items of an embodiment of the invention in the appended claims, but which is not restricted thereto, and various modifications are possible without deviating from the teachings of the embodiments of the invention.

More specifically, in the embodiment of the invention, a photoelectric conversion device corresponds to the photoelectric conversion device 230, for example. In addition, a collector lens corresponds to the on-chip lens 210, for example. In addition, a fluid lens corresponds to the fluid lens 100, for example. In addition, a first fluid corresponds to the medium A (120), for example. In addition, a second fluid corresponds to the medium B (130), for example. In addition, an electrode corresponds to the electrodes 141 and 142, for example.

In addition, in the embodiment of the invention, a photoelectric conversion device corresponds to the photoelectric conversion device 230, for example. In addition, a collector lens corresponds to the on-chip lens 210, for example. In addition, a fluid lens corresponds to the fluid lens 319, for example.

In addition, a first fluid corresponds to the medium A (120), for example. In addition, a second fluid corresponds to the medium B (130), for example. In addition, an electrode corresponds to the electrodes 141 and 142, for example. In addition, a solid lens group corresponds to the solid lens group 310, for example.

In addition, in the embodiment of the invention, a lens position sensor corresponds to the solid lens control part 325, for example.

In addition, in the embodiment of the invention, an angular velocity sensor corresponds to the angular velocity sensor 326, for example.

In addition, in the embodiment of the invention, a temperature sensor corresponds to the temperature sensor 327, for example.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device comprising:
a plurality of photoelectric conversion devices configured to convert a received light into an electronic signal;
a plurality of collector lenses configured to collect a light and to supply the light to the plurality of the photoelectric conversion devices, the collector lenses being arranged before each of the plurality of the photoelectric conversion devices; and
a fluid lens configured to refract a light and to supply the light to the plurality of the collector lenses, the fluid lens being arranged before the plurality of the collector lenses,
wherein the fluid lens has a first fluid and a second fluid with refractive indices different from each other and an electrode that applies a voltage to the first fluid and the second fluid, and
the fluid lens changes an interface topology between the first fluid and the second fluid in accordance with a voltage to be applied to the electrode and varies a refractive index of a light supplied to each of the plurality of the collector lenses.

2. The imaging device according to claim 1, wherein the first fluid and the second fluid are a liquid.

3. The imaging device according to claim 2, wherein the first fluid is an insulating oil, and the second fluid is a conductive aqueous solution.

4. An imaging apparatus comprising:
a plurality of photoelectric conversion devices configured to convert a received light into an electronic signal;
a plurality of collector lenses configured to collect a light and to supply the light to the plurality of the photoelectric conversion devices, the collector lenses being arranged before each of the plurality of the photoelectric conversion devices;
a fluid lens configured to refract a light and to supply the light to the plurality of the collector lenses, the fluid lens being arranged before the plurality of the collector lenses; and
a solid lens group configured to allow a light from a subject to enter the fluid lens, the solid lens group being arranged before the fluid lens,
wherein the fluid lens has a first fluid and a second fluid with refractive indices different from each other and an electrode that applies a voltage to the first fluid and the second fluid, and
the fluid lens changes an interface topology between the first fluid and the second fluid in accordance with a voltage to be applied to the electrode and varies a refractive index of a light supplied to each of the plurality of the collector lenses.

5. The imaging apparatus according to claim 4, further comprising:
a lens position sensor configured to detect at least one position of a lens in the solid lens group,
wherein a voltage to be applied to the electrode is changed in accordance with the position of the lens detected by the lens position sensor.

6. The imaging apparatus according to claim 4, further comprising:
an angular velocity sensor configured to detect an angular velocity applied to imaging apparatus,
wherein a voltage to be applied to the electrode is changed in accordance with an angular velocity detected by the angular velocity sensor.

7. The imaging apparatus according to claim 4, further comprising:
a temperature sensor configured to detect an ambient temperature of imaging apparatus,
wherein a voltage to be applied to the electrode is changed in accordance with a temperature detected by the temperature sensor.

8. An imaging method of an imaging device having a plurality of photoelectric conversion device, a plurality of collector lenses arranged before each of the plurality of the photoelectric conversion devices, and a fluid lens arranged before the plurality of the collector lenses, the method comprising the step of:
refracting a light and supplying the light to each of the plurality of the collector lenses while an interface topology between a first fluid and a second fluid being changed in accordance with a voltage to be applied to an electrode, wherein the fluid lens having the first fluid and the second fluid with refractive indices different from each other, and having the electrode that applies a voltage to the first fluid and the second fluid;
collecting the light supplied from the fluid lens by the plurality of the collector lenses and supplying the light to the plurality of the photoelectric conversion devices; and
receiving the light supplied from the plurality of the collector lenses by the plurality of the photoelectric conversion devices and converting the light into an electronic signal.

9. An imaging method of an imaging apparatus having a plurality of photoelectric conversion device, a plurality of collector lenses arranged before each of the plurality of the photoelectric conversion devices, a fluid lens arranged before the plurality of the collector lenses, and a solid lens group arranged before the fluid lens, the method comprising the steps of:
allowing a light from a subject to enter the fluid lens by the solid lens group;
refracting the light inputted by the solid lens group and supplying the light to each of the plurality of the collector lenses while an interface topology between a first fluid and a second fluid being changed in accordance with a voltage to be applied to an electrode, wherein the fluid lens having the first fluid and the second fluid with refractive indices different from each other and having the electrode that applies a voltage to the first fluid and the second fluid;
collecting the light supplied from the fluid lens by the plurality of the collector lenses and supplying the light to the plurality of the photoelectric conversion devices; and
receiving the light supplied from the plurality of the collector lenses by the plurality of the photoelectric conversion devices and converting the light into an electronic signal.
